(19) United States
(12) Patent Application Publication
(10) Pub. No.: US 2025/0173666 A1
(43) Pub. Date: May 29, 2025

(54) Devices and Methods for Object Tracking During Logistics Operations

(71) Applicant: ZEBRA TECHNOLOGIED CORPORATION, Lincolnshire, IL (US)

(72) Inventor: David Bellows, Ford Salonga, NY (US)

(21) Appl. No.: 18/523,444

(22) Filed: Nov. 29, 2023

(51) Int. Cl. G06Q 10/0833; G06K 7/10

(52) U.S. Cl. CPC G06Q 10/0833; G06K 7/10297

(57) ABSTRACT

Systems and methods for object tracking are disclosed herein. The method receives, by a first device and during a first period, first information of at least one first element associated with a user within a first area and second information of at least one second element associated with an object positioned within the first area. The method determines, based on the second information, whether the object is associated with the first area, and identifies the at least one second element as anomalous when the object is not associated with the first area. The method determines whether the first device receives the first information during a second time period and whether the first device receives the second information during the second time period when the first device does not receive the first information during the second time period. The method transmits a notification when the first device receives the second information during the second time period.

### BACKGROUND

Logistics operations can include the transportation and distribution (e.g., delivery) of objects (e.g., parcels, packages, goods, items, freight, etc.) to destination locations (e.g., residences or businesses). A loading logistics operation can involve the loading of hundreds, if not, thousands of objects into one or more areas (e.g., one or more containers where each container can be implemented as a storage unit affixed to or stored in a vehicle or a storage area integrated in at least a portion of a vehicle) for transportation and distribution. Objects can be retrieved from a container and delivered at respective destination locations. The large number of objects to be loaded into one or more containers for transportation and distribution of these objects can yield errors during a loading process (e.g., an object loaded into an incorrect container) that can impede the delivery of these objects at respective destination locations.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an example environment where an embodiment of the present disclosure may be implemented.

FIG. 2 is a diagram illustrating an embodiment of a system of the present disclosure for object tracking during logistics operations.

FIG. 3 is a diagram illustrating an embodiment of a system of the present disclosure and components of the device 112 of FIGS. 1 and 2.

FIG. 4 is a flowchart illustrating processing steps carried out by an embodiment of the present disclosure.

FIG. 5 is a table illustrating the processing steps of FIG. 4.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, logistics operations can include the transportation and distribution (e.g., delivery) of objects (e.g., parcels, packages, goods, items, freight, etc.) to destination locations (e.g., residences or businesses). A loading logistics operation can involve the loading of hundreds, if not, thousands of objects into one or more areas (e.g., one or more containers where each container can be implemented as a storage unit affixed to or stored in a vehicle or a storage area integrated in at least a portion of a vehicle) for transportation and distribution. Objects can be retrieved from the container and delivered at respective destination locations.

The large number of objects to be loaded into one or more containers for transportation and distribution of these objects can yield errors during a loading process (e.g., an object loaded into an incorrect container) that can impede the delivery of these objects at respective destination locations. For example, when an object is loaded into an incorrect container, an operator (e.g., driver) of a vehicle having a container affixed thereto or integrated therein can adjust a route of the vehicle to deliver the improperly loaded object, rendezvous with another operator of another vehicle having the correct container affixed thereto or integrated therein to transfer the improperly loaded object to be delivered, or return to a facility (e.g., a warehouse, manufacturing facility, retail facility, and transit facility such as an airport, depot, or the like) with the undelivered object to be loaded on the correct container the following day. These mitigation measures can be inefficient, time-consuming, and/or cost-prohibitive.

Conventional systems and methods utilize static and/or manual processes to identify objects loaded into a container. For example, a worker (e.g., a loader) can manually scan identifying information (e.g., a barcode) of each object being loaded into a container and, after the container is loaded, the worker and/or a supervisor can identify and remove an object that is not associated with the container (e.g., if the identifying information of the object does not match an object manifest of the container). This process is manual (e.g., relies on human intervention) and, as such, can be time-consuming, cost-prohibitive, and subject to human error. For example, a worker can omit scanning an object due to a volume and/or similarity of objects and/or overlook removing an object from a container that is not associated with the container due to a volume of loaded objects (e.g., an object can be hidden or buried by other objects) and/or space constraints within the loaded container thereby limiting a mobility of a worker to identify an object that is not associated with the container.

In another example, a system or device can read an identifier element (e.g., a radio frequency identification (RFID) tag) of each object being loaded into a container to identify the object and can transmit an alert to a worker to remove the object from the container if the object is not associated with the container (e.g., if information of the object identifier element does not match an object manifest of the container). However, due to timing constraints (e.g., next day or two-day delivery) and productivity incentives (e.g., a number of containers loaded during a work shift), a worker generally loads a plurality of containers as quickly as possible by transporting a plurality of objects from container to container, dropping off the individual objects associated with (e.g., that belong in) each container, to load a respective object in an associated container (e.g., a correct container) among the plurality of containers. As such, a worker can transport objects into a first container, even if the objects are meant to eventually be loaded into one of the subsequent containers. During this loading process, since a worker can transport multiple respective objects proximate to and/or into a container that the respective object is not associated with, premature alerts (e.g., false alerts) may be transmitted to the worker to remove each respective object. Consequently, the worker can be conditioned to ignore such received alerts (e.g., a true or false alert) rendering the system or device ineffective. In addition, during a loading process, the worker may overlook the receipt of a helpful alert (e.g., true alert) or view the alert after moving to a different container thereby delaying the removal of an object (if not forgetting to remove an object) from a container that the object is not associated with.

As such, conventional systems suffer from a general lack of versatility because these systems cannot automatically identify objects in a container during a loading logistics operation and automatically and dynamically mitigate the transmission of a false alert in real time when an object is temporarily positioned in a container that the object is not associated with and transmit an alert in real time when an object is improperly loaded in a container that the object is not associated with (e.g., loaded into an incorrect container). Overall, this lack of versatility causes conventional systems to provide underwhelming performance and reduce the efficiency and general timeliness of executing and completing logistics operations including the loading of hundreds, if not, thousands of objects into one or more containers for the transportation and distribution of these objects to destination locations.

Thus, it is an objective of the present disclosure to eliminate these and other problems with conventional systems and methods via systems and methods that can automatically identify objects in a container during a loading logistics operation and automatically and dynamically mitigate the transmission of a false alert in real time when an object is temporarily positioned in a container that the object is not associated with and transmit an alert in real time when an object is improperly loaded in a container that the object is not associated with (e.g., loaded into an incorrect container). For example, the systems and methods of the present disclosure alleviate the issues present with conventional systems by automatically and dynamically mitigating the transmission of a false alert in real time when an object is temporarily positioned in a container that the object is not associated with and transmitting an alert in real time when an object is improperly loaded in a container that the object is not associated with (e.g., loaded into an incorrect container). The systems and methods of the present disclosure realize these functionalities (and advantages thereof) based on first and second information received by a reader or transceiver device (e.g., an RFID reader or transceiver or a BLE equipped device having a BLE radio and antenna) during at least one of a first time period and a second time period, where the first information is indicative of at least one first identifier element (e.g., an RFID tag or BLE beacon) associated with a user (e.g., a worker) within a first area (e.g., a container) and the second information is indicative of at least one second identifier element (e.g., an RFID tag or BLE beacon) associated with an object positioned within the first area.

In accordance with the above, and with the disclosure herein, the present disclosure includes improvements in computer functionality or improvements to other technologies at least because the present disclosure describes that, e.g., logistics operational systems, and their related various components, may be improved or enhanced with the disclosed dynamic system features and methods that provide more efficient working conditions for workers and improved monitoring and management of logistics operations for system administrators. That is, the present disclosure describes improvements in the functioning of an operational system itself or “any other technology or technical field” (e.g., the field of distributed/commercial/industrial logistics information systems). For example, the disclosed dynamic system features and methods improve and enhance the loading of objects into a container by introducing the automatic and dynamic mitigation of the transmission of a false alert in real time when an object is temporarily positioned in a container that the object is not associated with and transmission of an alert in real time when an object is improperly loaded in a container that the object is not associated with (e.g., loaded into an incorrect container) to mitigate (if not eliminate) worker error and eliminate inefficiencies typically experienced over time by systems lacking such features and methods. This improves the state of the art at least because such previous systems are inefficient as they lack the ability to automatically and dynamically mitigate the transmission of a false alert in real time when an object is temporarily positioned in a container that the object is not associated with and transmit an alert in real time when an object is improperly loaded in a container that the object is not associated with (e.g., loaded into an incorrect container) based on information and/or a state of a user and an object (e.g., first information of at least one first identifier element associated with a user within a first area and second information of at least one second identifier element associated with an object positioned within the first area).

In addition, the present disclosure applies various features and functionality, as described herein, with, or by use of, a particular machine, e.g., a processor, a reader or transceiver device (e.g., an RFID reader or transceiver or a BLE equipped device having a BLE radio and antenna), a mobile computing device, and/or other hardware components as described herein. Moreover, the present disclosure includes specific features other than what is well-understood, routine, conventional activity in the field, or adding unconventional steps that demonstrate, in various embodiments, particular useful applications, e.g., controlling signal processing protocols of a reader or transceiver device (e.g., an RFID reader or transceiver or a BLE equipped device having a BLE radio and antenna) in connection with information and/or a state of a user and/or object (e.g., a position of a user and/or object).

Accordingly, it would be highly beneficial to develop a system and method that can identify objects in a container during a loading logistics operation and automatically and dynamically mitigate the transmission of a false alert in real time when an object is temporarily positioned in a container that the object is not associated with and transmit an alert in real time when an object is improperly loaded in a container that the object is not associated with (e.g., loaded into an incorrect container). The systems and methods of the present disclosure address these and other needs.

In an embodiment, the present disclosure is directed to a method. The method comprises receiving, by a first device and during a first period, first information of at least one first element associated with a user within a first area and second information of at least one second element associated with an object positioned within the first area; determining, based on the second information, whether the object is associated with the first area; identifying the at least one second element as anomalous when the object is not associated with the first area; determining whether the first device receives the first information during a second time period; determining whether the first device receives the second information during the second time period when the first device does not receive the first information during the second time period; and transmitting a notification when the first device receives the second information during the second time period, the notification being indicative of the object not being associated with the first area and being positioned within the first area.

In an embodiment, the present disclosure is directed to a device. The device comprises a memory and a processor. The memory is configured to store computer executable instructions, and the processor is configured to interface with the memory and execute the computer executable instructions to cause the processor to: receive, during a first period, first information of at least one first element associated with a user within a first area and second information of at least one second element associated with an object positioned within the first area, determine, based on the second information, whether the object is associated with the first area, identify the at least one second element as anomalous when the object is not associated with the first area, determine whether the device receives the first information during a second time period, determine whether the device receives the second information during the second time period when the device does not receive the first information during the second time period, and transmit a notification when the device receives the second information during the second time period, the notification being indicative of the object not being associated with the first area and being positioned within the first area.

In an embodiment, the present disclosure is directed to a tangible machine-readable medium having instructions stored thereon which, when executed by a processor, causes the processor to carry out the steps of: receiving, by a first device and during a first period, first information of at least one first element associated with a user within a first area and second information of at least one second element associated with an object positioned within the first area; determining, based on the second information, whether the object is associated with the first area; identifying the at least one second element as anomalous when the object is not associated with the first area; determining whether the first device receives the first information during a second time period; determining whether the first device receives the second information during the second time period when the first device does not receive the first information during the second time period; and transmitting a notification when the first device receives the second information during the second time period, the notification being indicative of the object not being associated with the first area and being positioned within the first area.

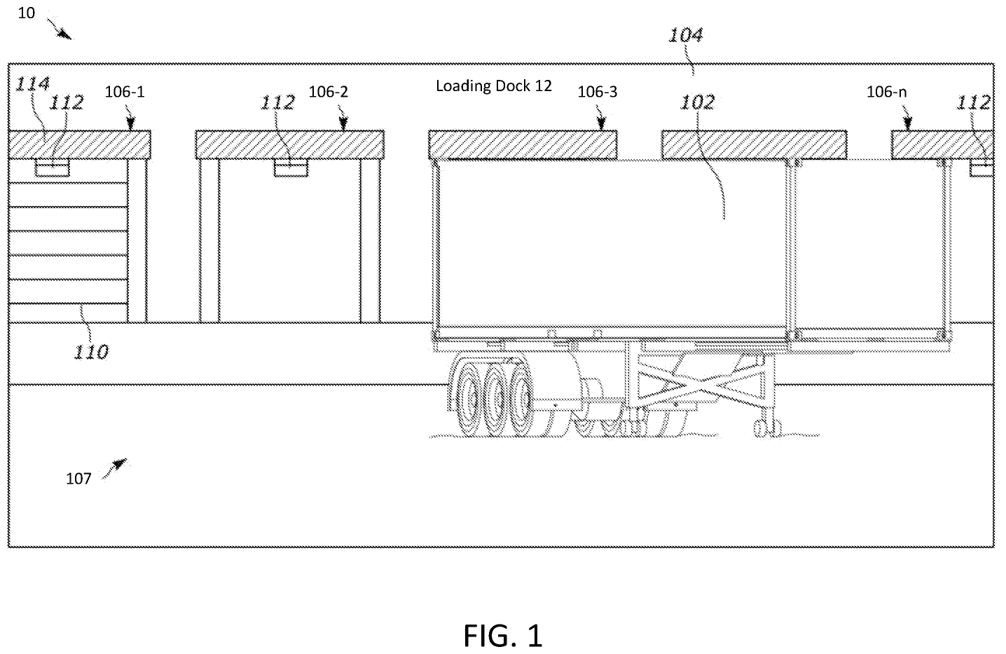

Turning to the Drawings, FIG. 1 is a diagram 10 illustrating an example environment where an embodiment of the present disclosure may be implemented. In the present example, the environment is provided in a form of a loading dock 12 of a facility 104 where one or more containers 102 (e.g., a trailer as shown) are loaded with various objects (e.g., parcels, packages, goods, items, freight, etc.) and/or where various objects are unloaded from the one or more containers 102.

The loading dock 12 includes a plurality of load bays 106-1, 106-2, 106-3, and 106-n facing a lot 107 (e.g., a parking lot) where vehicles, such as semi-trucks (not shown), deliver and pick up the containers 102. To be loaded or unloaded, an opening of a container is positioned in line with one of the loading bays (in this case 106-3). Each load bay 106 can include a bay door 110, a reader or transceiver device 112 (e.g., an RFID reader or transceiver or a BLE equipped device having a BLE radio and antenna), and an awning 114.

A bay door 110 can be lowered to close the respective load bay 106 or raised to open the respective load bay 106 allowing an interior of the facility 104 to be accessible there through. A reader or transceiver device 112 can be mounted near the container 102 loading area including, but not limited to, in an upper section of a load bay 106 outside the door 110 and facing the lot 107 and an interior of a container 102, an interior of a container 102 (e.g., on a ceiling, a wall, or at any suitable location on an interior of a container 102), or a rear and/or exterior of a container 102 (e.g., a roof, a rear bumper, a rear door or at any suitable location on an exterior of a container 102). The reader or transceiver device 112 can be mounted under the awning 114 to protect the reader or transceiver device 112 from inclement weather. Once docked, objects (e.g., parcels, packages, goods, items, freight, etc.) can be loaded onto/unloaded from the container 102 with a reader or transceiver device 112 maintaining a view of the rear/inside of the container 102.

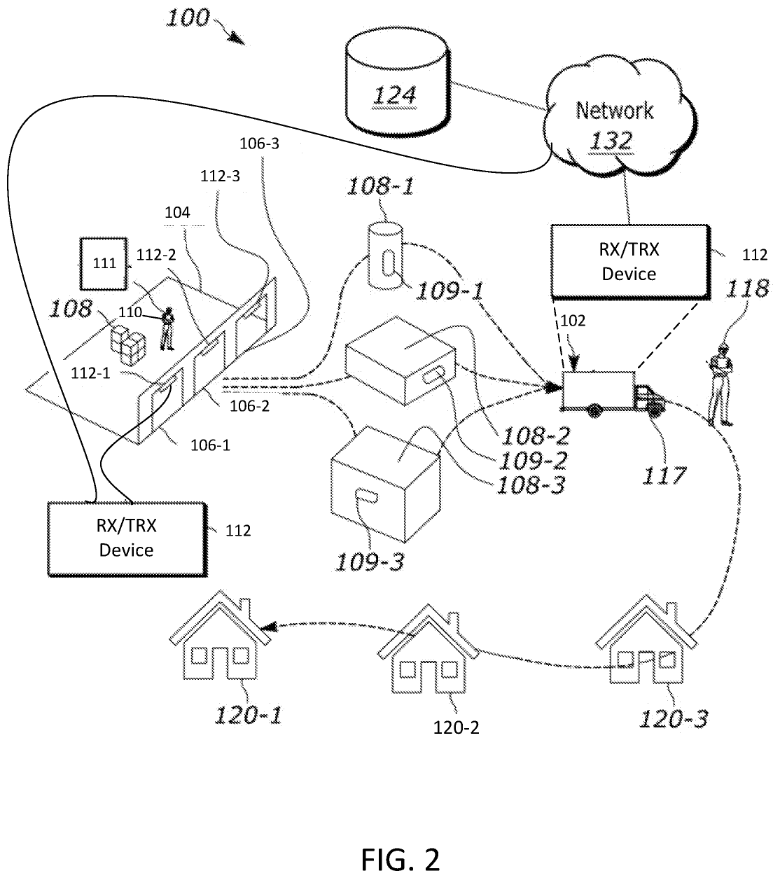

FIG. 2 is a diagram 100 illustrating an embodiment of a system of the present disclosure for object tracking during logistics operations (e.g., a loading logistics operation). As shown in FIG. 2 and mentioned above, a facility 104 (e.g., a warehouse, manufacturing facility, retail facility, and transit facility such as an airport, depot, or the like) can include a portion of a building (e.g., the loading dock 12 of FIG. 1), a cross dock or portion thereof, including load bays 106-1, 106-2, and 106-3 (collectively referred to as load bays 106, and generically referred to as a load bay 106). In other examples, smaller or greater numbers of load bays 106 may be included.

As mentioned above in relation to FIG. 1, the load bays 106 may, for example, be arranged along an outer wall of the facility 104, such that one or more containers 102 can be positioned proximate to the load bays 106 from the exterior of the facility 104. Each load bay 106 may be equipped with a respective reader or transceiver device 112-1, 112-2, and 112-3 (collectively referred to as readers or transceivers 112, and generically referred to as reader or transceiver 112) and can identify the facility 104 and/or each load bay 106. Alternatively, a reader or transceiver device 112 can be mounted in an interior of a container 102 (e.g., on a ceiling, a wall, or at any suitable location on an interior of a container 102), or a rear and/or exterior of a container 102 (e.g., a roof, a rear bumper, a rear door or at any suitable location on an exterior of a container 102). A reader or transceiver 112 can include, but is not limited to, an RFID reader or transceiver and a BLE equipped device having a BLE radio and antenna.

Each load bay 106 may be configured to accommodate a container 102 such that one or more containers 102 can be positioned proximate to the load bays 106 from the exterior of the facility 104. The container 102 can be implemented as, but is not limited to, a storage unit affixed to or stored in a vehicle 117 such as a box portion of a box truck in which the box is affixed to a body of a vehicle which also supports a cab, powertrain, and the like, a semi-trailer including an enclosed box (e.g., trailer) affixed to a platform including one or more sets of wheels and a hitch assembly for towing by a powered vehicle, and a unit loading device (ULD) of the type employed to load luggage, freight and the like into aircraft. The container 102 can also be implemented as, but is not limited to, a storage area integrated in at least a portion of a vehicle including a van (e.g., a cargo van or a sprinter van) and a sports utility vehicle (SUV). The container 102 may have a substantially horizontal internal depth, extending from an open end (e.g., a wall with a door or other opening allowing access to an interior of the container 102) of the container 102 to a closed end, a substantially horizontal internal width perpendicular to the depth, and a substantially vertical internal height.

The load bays 106 enable access from within the facility 104 to an exterior of the facility 104 where a container 102 is positioned. For example, each load bay 106 includes an opening, e.g., in a wall of the facility 104, that allows a worker 110 (e.g., an individual including, but not limited to, a manager, employee, loader, contractor, etc.) and/or equipment within the facility 104 to access an interior of the container 102. When a container 102 is positioned at a load bay 106 (e.g., with the open end of the container 102 substantially flush with the opening of the load bay 106), objects 108-1, 108-2, and 108-3 (collectively referred to as the objects 108, and generically referred to as an object 108) can be loaded into the container 102 (e.g., from a staging area for unloaded items 108) or unloaded from the container 102 for processing within the facility 104. In some examples, the facility 104 includes one or more conveyor belts or other item transport mechanisms (not shown) to transport and load objects 108 into the container 102 or unload objects 108 from the container 102 to other locations within the facility 104. Each object 108 may be equipped with a respective identifier element such as a transmitter or transceiver 109-1, 109-2, and 109-3 (collectively referred to as transmitters or transceivers 109, and generically referred to as a transmitter or transceiver 109) to identify the object 108. A transmitter or transceiver 109 can include, but is not limited to, an RFID tag and a BLE beacon.

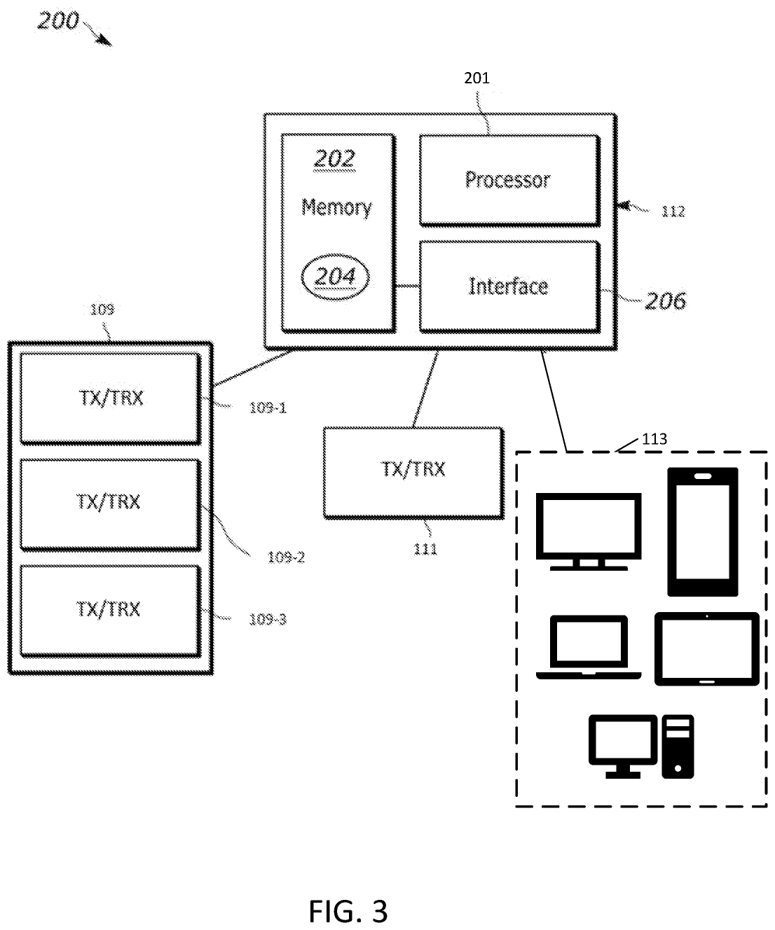

Each worker 110 may have a respective identifier element such as a transmitter or transceiver 111 (e.g., an RFID tag or BLE beacon wearable including, but not limited to, an identification card, a badge, and a wristband) to identify him/herself. In an embodiment, each object 108 may be equipped with a transmitter or transceiver 109 (e.g., an RFID tag) and each worker 110 may be equipped with a transmitter or transceiver 111 (e.g., an RFID tag). Alternatively, in another embodiment, each object 108 may be equipped with a transmitter or transceiver 109 (e.g., a BLE beacon) and each worker 110 may be equipped with a transmitter or transceiver 111 (e.g., a BLE beacon). Alternatively, in another embodiment, each object 108 may be equipped with a transmitter or transceiver 109 (e.g., an RFID tag) and each worker 110 may be equipped with a transmitter or transceiver 111 (e.g., a BLE beacon). Alternatively, in another embodiment, each object may be equipped with a transmitter or transceiver 109 (e.g., a BLE beacon) and each worker 110 may be equipped with a transmitter or transceiver 111 (e.g., an RFID tag). As discussed in further detail below, each worker 110 can be associated with, possess, and/or be proximate to a device 113 (as shown in FIG. 3) including, but not limited to, a mobile computing device (e.g., a smart phone, a tablet, a laptop, a smart watch), a computer, a display, etc.

In logistics operations, a wide variety of objects including, but not limited to parcels, packages, goods, items, freight, etc., can be transported from origin locations to destination locations, often via a variety of intermediate locations. As shown in FIG. 2, objects 108 may be transported from the facility 104 to destination locations, such as residences 120-1, 120-2, and 120-3 (collectively referred to as the destination locations 120, and generically referred to as a destination location 120) via a container 102 implemented as a storage unit affixed to or stored in a vehicle 117 (e.g., a box truck, a semi-trailer, or the like) or a container 102 implemented as a storage area integrated in at least a portion of a vehicle 117 such as a van (e.g., a cargo van or a sprinter van) and an SUV. At each destination location 120, the operator 118 or an autonomous apparatus such as a drone can retrieve the relevant object(s) 108 destined for that destination location 120, remove the relevant object(s) 108 from the container 102, and deliver the relevant objects(s) 108 to the destination location 120 before proceeding to the next destination location 120. Additionally, objects 108 can be collected from these destination locations 120 and/or from other destination locations between deliveries. The number of objects 108, and the number of destination locations 120, can vary, and need not be equal in other examples (e.g., more than one object 108 can be delivered to a single destination location 120).

Associations between objects 108 and destination locations 120 can be stored in a central repository 124, which can also contain data defining a route that specifies a sequence in which the container 102 is to travel to the destination locations 120. The repository 124 can also contain a variety of other data regarding the objects 108, such as sender identities, object 108 and worker 110 associations, container 102 associations or locations, object identifier elements (e.g., a transmitter or transceiver 109 such as an RFID tag or a BLE beacon uniquely distinguishing each object 108 from other items 108), object dimensions (e.g., one or more of width, length, and height), object weights, and the like.

As mentioned above, a loading logistics operation can involve the loading of hundreds, if not, thousands of objects 108 into one or more containers 102. The large number of objects 108 to be loaded into the one or more containers 102 for transportation and distribution of these objects 108 can yield errors during a loading process (e.g., an object 108 loaded into an incorrect container 102) that can impede the delivery of these objects 108 at respective destination locations 120. For example, when an object 108 is loaded into an incorrect container 102, an operator 118 (e.g., driver) of a vehicle 117 having a container 102 affixed thereto or integrated therein can adjust a route of the vehicle 117 to deliver the improperly loaded object 108, rendezvous with another operator 118 of another vehicle 117 having the correct container 102 affixed thereto or integrated therein to transfer the improperly loaded object 108 to be delivered, or return to a facility 104 with the undelivered object 108 to be loaded on the correct container 102 the following day. These mitigation measures can be inefficient, time-consuming, and/or cost-prohibitive.

As described in greater detail below, the system includes components and functionality to identify objects 108 in a container 102 during loading logistics operations and automatically and dynamically mitigate the transmission of a false alert in real time when an object 108 is temporarily positioned in a container 102 that the object 108 is not associated with and transmit an alert in real time when an object 108 is improperly loaded in a container 102 that the object is not associated with (e.g., loaded into an incorrect container). The system includes a reader or transceiver device 112 associated with a container 102, a load bay 116, and/or a vehicle 117. The reader or transceiver device 112 is communicatively coupled with object identifier elements (e.g., a transmitter or transceiver 109) and worker 110 identifier elements (e.g., a transmitter or transceiver 111) disposed within an interior of the container 102, and at least one device 113 including, but not limited to, a mobile computing device (e.g., a smart phone, a tablet, a laptop, a smart watch), a computer, a display, etc. disposed within an interior and/or exterior of the container 102 and/or proximate to the container 102 and/or load bay 106. As shown in FIG. 2, the reader or transceiver device 112 can exchange data with the central repository 124, e.g., via a network 132 implemented as any suitable combination of local and wide-area networks. The reader or transceiver device 112 can track each object 108 as each object 108 is loaded in the container 102, e.g., on a support structure such as a shelf. The reader or transceiver device 112 can therefore detect and/or record each object 108 positioned in the container 102 and can generate and update an inventory of objects 108 in the container 102.

FIG. 3 is a diagram 200 illustrating an embodiment of a system of the present disclosure and components of the device 112 of FIGS. 1 and 2. The reader or transceiver device 112 can include, but is not limited to, an RFID reader or transceiver and a BLE equipped device having a BLE radio and antenna including, but not limited to, a gateway, a mobile computing device (e.g., a tablet or mobile computer), a smartphone, or other device with BLE capability for reading and/or detecting BLE beacons. In an embodiment, the reader or transceiver device 112 can include an RFID reader or transceiver but not a BLE equipped device having a BLE radio and antenna. In another embodiment, the reader or transceiver device 112 can include a BLE equipped device having a BLE radio and antenna but not an RFID reader or transceiver. In yet another embodiment, the reader or transceiver device 112 can include an RFID reader or transceiver and a BLE equipped device having a BLE radio and antenna. As mentioned above, the reader or transceiver device 112 is communicatively coupled with object identifier elements (e.g., a transmitter or transceiver 109) and worker 110 identifier elements (e.g., a transmitter or transceiver 111) disposed within an interior of the container 102, and at least one device 113 including, but not limited to, a mobile computing device (e.g., a smart phone, a tablet, a laptop, a smart watch), a computer, a display, etc. disposed within an interior and/or exterior of the container 102 and/or proximate to the container 102 and/or load bay 106.

As illustrated in FIG. 3, the reader or transceiver device 112 includes a processor 201, such as a central processing unit (CPU), a graphics processing unit (GPU), or a combination thereof. The processor 201 is communicatively coupled with a non-transitory computer-readable storage medium such as a memory 202, implemented as a suitable combination of volatile and non-volatile memory elements. The memory 202 can store a plurality of computer-readable instructions, e.g., in the form of a tracking application 204 executable by the processor 201 to perform functionality discussed in greater detail below. The application 204, in other examples, can be implemented as a suite of distinct applications, or as a dedicated hardware element (e.g., an application-specific integrated circuit (ASIC)).

The reader or transceiver device 112 also includes a communications interface 206 enabling communication between the reader or transceiver device 112 and other computing devices (e.g., a server hosting the central repository 124), via suitable short-range links, networks such as the network 132, and the like. The interface 206 therefore includes suitable hardware elements, executing suitable software and/or firmware, to communicate over the network 132 and/or other communication links.

As mentioned above, the reader or transceiver device 112 can be mounted near the container 102 loading area including, but not limited to, in an upper section of a load bay 106 outside the door 110 and facing the lot 107 and an interior of a container 102, an interior of a container 102 (e.g., on a ceiling, a wall, or at any suitable location on an interior of a container 102), or a rear and/or exterior of a container 102 (e.g., a roof, a rear bumper, a rear door or at any suitable location on an exterior of a container 102). The reader or transceiver device 112 can be mounted under a bay awning 114 (as shown in FIG. 1) to protect the reader or transceiver device 112 from inclement weather. Objects 108 (e.g., parcels, packages, goods, items, freight, etc.) can be loaded onto/unloaded from the container 102 such that a reader or transceiver device 112 maintains a view of the rear/inside of the container 102.

An interior or exterior reader or transceiver 112 can include, for example, a directional reader configured to detect at least one transmitter or transceiver 111 of a worker 110 when the worker is within the container 102 and transmitters or transceivers 109 affixed to objects 108, or affixed to bins or containers carrying the items 108, when items 108 are positioned in the container 102. The transmitter or transceiver 111 can be an RFID tag or BLE beacon (e.g., a wearable including, but not limited to, an identification card, a badge, and a wristband) and can uniquely distinguish each worker 110 from other workers 110. The transmitters or transceivers 109 can be one of an RFID tag or a BLE beacon and can uniquely distinguish each item 108 from other items 108.

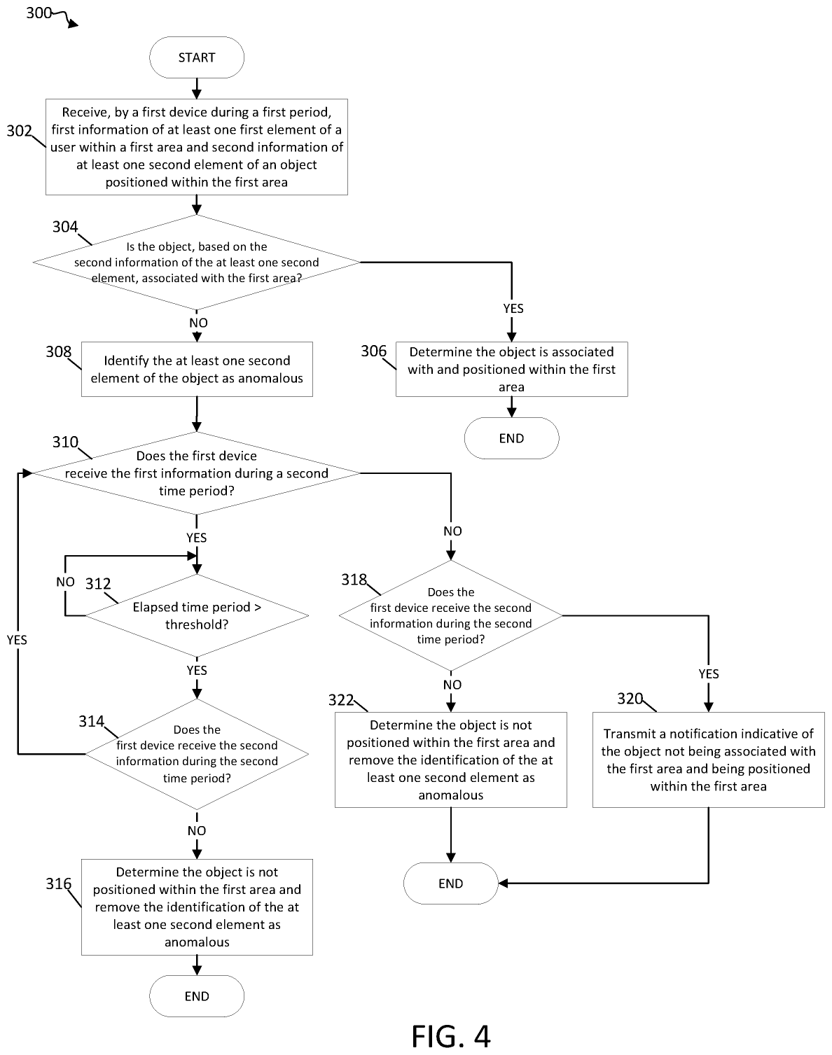

FIG. 4 is a flowchart 300 illustrating processing steps carried out by an embodiment of the present disclosure. The processing steps will be described in conjunction with their performance in the system (e.g., by the reader or transceiver device 112 in conjunction with the transmitter or transceiver 111 of a worker 110 and transmitters or transceivers 109 affixed to objects 108). In general, via performance of the processing steps, the system can automatically and dynamically mitigate the transmission of a false alert in real time when an object 108 is temporarily positioned in a container 102 that the object 108 is not associated with and transmit an alert in real time when an object is improperly loaded in a container that the object is not associated with (e.g., loaded into an incorrect container). The systems and methods of the present disclosure realize these functionalities (and advantages thereof) based on first and second information received by a reader or transceiver device (e.g., an RFID reader or transceiver or a BLE equipped device having a BLE radio and antenna) during at least one of a first time period and a second time period, where the first information is indicative of at least one first identifier element (e.g., a transmitter or transceiver 111) associated with a user (e.g., a worker 110) within a first area (e.g., a container 102) and the second information is indicative of at least one second identifier element (e.g., a transmitter or transceiver 109) associated with an object 108 positioned within the first area.

Beginning in step 302, the system receives, by a first device during a first period, first information of at least one first element of a user within a first area and second information of at least one second element of an object positioned within the first area. For example, a reader or transceiver device 112 can receive a signal including information of a transmitter or transceiver 111 of a worker 110 within a container 102 and a signal including information of a transmitter or transceiver 109 of an object 108 positioned within the container 102. The first time period can be indicative of a first instance of receiving the signal from the transmitter or transceiver 111 of the worker 110 within the container 102 and receiving the signal from the transmitter or transceiver 109 of the object 108 positioned within the container 102. The system can distinguish between a worker 110 and an object 108 based on an encoding (e.g., identifying information) of each of a transmitter or transceiver 111 of a worker 110 and a transmitter or transceiver 109 of an object 108. For example, a serial or identification number of a transmitter or transceiver 111 can begin with a “1” whereas a serial or identification number of a transmitter or transceiver 109 can begin with a “1”. It should be understood that different methods and/or mechanisms can be utilized to distinguish between a worker 110 and an object 108. Additionally, a worker 110 can be, but need not be, associated with an object 108.

Then, in step 304, the system determines whether the object, based on the second information of the at least one second element, is associated with the first area. For example, the system can determine, based on the information received by the reader or transceiver device 112 from the transmitter or transceiver 109, whether the object 108 is associated with the container 102 (e.g., if the information of the object 108 does or does not match an object manifest of the container 102). If the system determines that the object is associated with the first area, then the process proceeds to step 306. In step 306, the system determines that the object is associated with and positioned within the first area. For example, the system determines that the object 108 matches an object manifest of the container 102 and is positioned within the container 102.

Alternatively, if the system determines that the object is not associated with the first area, then the process proceeds to step 308. In step 308, the system identifies the at least one second element of the object as anomalous. For example, the system determines that the object 108 does not match an object manifest of the container 102 and, as such, identifies the transmitter or transceiver 109 (i.e., the object 108) as anomalous.

In step 310, the system determines whether the first device receives the first information during a second time period. For example, the system can determine whether the reader or transceiver 112 receives the signal including information of the transmitter or transceiver 111 of a worker 110 within a container 102 during a second time period where the second time period is different from and subsequent to the first time period. The second time period can be indicative of a second instance of receiving the signal from the transmitter or transceiver 111 of the worker 110 within the container 102 and/or receiving the signal from the transmitter or transceiver 109 of the object 108 positioned within the container 102.

If the system determines that the first device receives the first information during the second time period, then the process proceeds to step 312. For example, if the system determines that the reader or transceiver 112 receives the signal from the transmitter or transceiver 111 of the worker 110 during the second time period, it can be indicative of the worker 110 being present within the container 102 during the first period and the second period. For example, the worker 110 may have remained within the container 102 from the first period to the second period. Alternatively, if the first and second time periods are sufficiently apart from one another, the worker 110 may have left an initial container 102 with an object 108, positioned the object 108 in another container 102, and returned to the initial container 102.

Alternatively, if the system determines that the first device does not receive the first information during the second time period, then the process proceeds to step 318 (discussed in greater detail below). For example, if the system determines that the reader or transceiver 112 does not receive the signal from the transmitter or transceiver 111 of the worker 110, it can be indicative of the worker 110 not being present within the container 102 from the first period to the second period. For example, the worker 110 could have moved to another container 102 after the first period. In some embodiments, the receipt of the first information during the second time period by a second device associated with a second load bay 106 and/or second container 102 can be a substitute for the first device not receiving the first information during the second time period. This can be another way, for example, to determine that the worker 110 could have moved to another container 102 after the first period.

In step 312, the system determines whether an elapsed time period exceeds a threshold. If the system determines that the elapsed time period does not exceed the threshold, then the process returns to step 312. Alternatively, if the system determines that the elapsed time period exceeds the threshold, then the process proceeds to step 314. In step 314, the system determines whether the first device receives the second information during the second time period. For example, the system can determine whether the reader or transceiver 112 receives the signal including information of the transmitter or transceiver 109 of an anomalous object 108 within a container 102 during a second time period where the second time period is different from and subsequent to the first time period.

If the system determines that the first device receives the second information during the second time period, then the process returns to step 310. For example, if the system determines that the reader or transceiver 112 receives the signal from the transmitter or transceiver 109 of the anomalous object 108, it can be indicative of the worker 110 and the anomalous object 108 remaining within the container 102 from the first period to the second period. As such, the system can automatically and dynamically mitigate the transmission of a false alert in real time because the system can determine that the anomalous object 108 is temporarily positioned in a container 102 since the worker 110 is also within the container 102 (e.g., the worker 110 has not moved to another container 102 after the first period without the anomalous object 108).

Alternatively, if the system determines that the first device does not receive the second information during the second time period, then the process proceeds to step 316. For example, if the system determines that the reader or transceiver 112 does not receive the signal from the transmitter or transceiver 109 of the object 108, it can be indicative of the worker 110 being present within the container 102 and the anomalous object 108 being removed from the container 102 after the first period and before the second period. In step 316, the system determines that the object is not positioned within the first area and removes the identification of the at least one second element as anomalous.

Returning to step 318, the system determines whether the first device receives the second information during the second time period. For example, the system can determine whether the reader or transceiver 112 receives the signal including information of the transmitter or transceiver 109 of the anomalous object 108 within a container 102 during a second time period where the second time period is different from and subsequent to the first time period. If the system determines that the first device receives the second information during the second time period, then the process proceeds to step 320. For example, if the system determines that the reader or transceiver 112 receives the signal from the transmitter or transceiver 109 of the anomalous object 108, it can be indicative of the worker 110 having moved to another container 102 and the anomalous object 108 remaining within the container 102 from the first period to the second period. As such, the system can automatically and dynamically transmit an alert in real time because the system can determine that the anomalous object 108 is positioned in the container 102 and that the worker 110 is not within the container 102 (e.g., the worker 110 has moved to another container 102 after the first period without the anomalous object 108).

In step 320, the system transmits a notification (e.g., an alert) indicative of the object 108 not being associated with the first area and being positioned within the first area. For example, the system transmits an alert because the anomalous object 108 is loaded in an incorrect container. The system can transmit the notification to one or more devices 113 associated with, possessed by, and/or proximate to a worker 110 (e.g., a worker 110 that moved to another container 102 after the first period without the anomalous object 108 and/or another worker 110 most proximate to the container 102 having the anomalous object 108 loaded therein), where the device 113 can include, but is not limited to, a mobile computing device (e.g., a smart phone, a tablet, a laptop, a smart watch), a computer, a display, etc. The system can also transmit the notification to one or more devices 113 associated with, possessed by, and/or proximate to a supervisor, and/or a system administrator where the device 113 can include, but is not limited to, a mobile computing device (e.g., a smart phone, a tablet, a laptop, a smart watch), a computer, a display, etc. Additionally, the system can transmit the notification to one or more devices 113 associated with, positioned in, and/or proximate to the first area and/or a second area different from the first area where the device 113 can include, but is not limited to, a mobile computing device (e.g., a smart phone, a tablet, a laptop, a smart watch), a computer, a display, etc. For example, the system can transmit a notification to a display associated with, positioned in, and/or proximate to a second area (e.g., another container 102 and/or load bay 106) different from the first area, where the second area is indicative of an area where a worker 110 is most recently detected (e.g., where a transmitter or transceiver 111 was last read within a predetermined time period). For example and referring to FIG. 2, a worker 110 may have moved from the container 102 in load bay 106-1 to another container 102 in load bay 106-2, and, as such, it may be practical to transmit the notification to a display of this second area (e.g., the another container 102 and/or load bay 106-2) even though the notification was generated based on received first information by a reader or transceiver device 112-1.

In some embodiments, the timing of the notification can be intentionally delayed until the worker 110 returns to the container 102 having the anomalous object 108. This return can be detected by the first device receiving the first information again during a later time period. If the timing of the notification generally coincides with the return of the worker 110 to the container 102 having the anomalous object 108, the worker 110 can correct the improperly loaded object 108 immediately. If the timing of the notification generally is too early, the worker 110 is more likely to forget the notification. The notification can be one or more of an audible indication, text, graphical indication, and a text to voice message.

Alternatively, if the system determines that the first device does not receive the second information during the second time period, then the process proceeds to step 322. In step 322, the system determines that the object 108 is not positioned within the first area and removes the identification of the at least one second element as anomalous. For example, this can be indicative of the worker 110 having moved to another container 102 with the anomalous object 108 after the first period and before the second period.

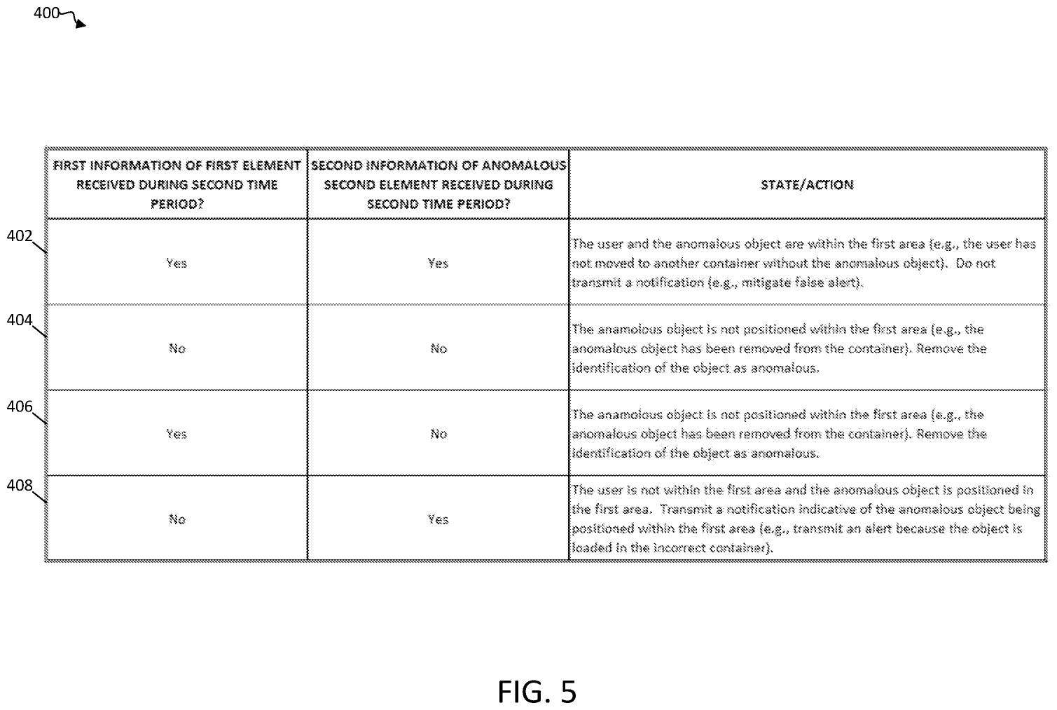

FIG. 5 is a table 400 illustrating the processing steps of FIG. 4. For example, row 402 is indicative of processing steps 310-314 of FIG. 4; row 404 is indicative of processing steps 310, 318, and 322; row 406 is indicative of processing steps 310-316; and row 408 is indicative of processing steps 310, 318 and 320.

While the present disclosure is implemented in an environment provided in a form of a loading dock 12 of a facility 104 where one or more containers 102 (e.g., a trailer as shown in FIG. 1) are loaded with various objects (e.g., parcels, packages, goods, items, freight, etc.), it should be understood that the present disclosure can apply to any logistics operation related to tracking individuals and/or objects and/or tracking and associating individuals with objects, devices, or other individuals to automatically and dynamically mitigate the transmission of a false alert. For example, the present disclosure can be implemented in a hospital environment where a worker (e.g., a nurse) can transport a plurality of objects (e.g., medications) to one or more patient rooms for consumption within a respective associated room without leaving a particular medication in a patient room that the particular medication is not associated with. In another example, the present disclosure can be implemented in an airport environment where a vehicle (e.g., a luggage cart) can transport a plurality of objects (e.g., pieces of luggage) to one or more airplane loading areas for loading from a respective associated loading area without leaving a particular piece of luggage in a loading area that the particular piece of luggage is not associated with. In another example, the present disclosure can be implemented in a manufacturing assembly line environment where a worker (e.g., a technician) can transport a plurality of objects (e.g., components) to one or more stations for use at a respective associated station without leaving a particular component at a station that the particular component is not associated with. In yet another example, the present disclosure can be implemented in a group environment where a worker (e.g., a guide) can guide a plurality of individuals to one or more areas of a building (e.g., a museum, factory, etc.) without leaving a particular individual in an area that is not associated with the guide.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method, comprising:
receiving, by a first device and during a first period, first information of at least one first element associated with a user within a first area and second information of at least one second element associated with an object positioned within the first area;
determining, based on the second information, whether the object is associated with the first area;
identifying the at least one second element as anomalous when the object is not associated with the first area;
determining whether the first device receives the first information during a second time period;
determining whether the first device receives the second information during the second time period when the first device does not receive the first information during the second time period; and
transmitting a notification when the first device receives the second information during the second time period, the notification being indicative of the object not being associated with the first area and being positioned within the first area.

2. The method of claim 1, further comprising:
removing the identification of the at least one second element as anomalous when the first device does not receive the second information during the second time period.

3. The method of claim 1, further comprising:
determining whether an elapsed time period exceeds a threshold when the first device receives the first information during the second time period;
determining whether the first device receives the second information during the second time period when the elapsed time period exceeds the threshold; and
determining the object is not positioned within the first area and removing the identification of the at least one second element as anomalous when the first device does not receive the second information during the second time period.

4. The method of claim 1, further comprising:
determining whether an elapsed time period exceeds a threshold when the first device receives the first information during the second time period;
determining whether the first device receives the second information during the second time period when the elapsed time period exceeds the threshold; and
determining whether the first device receives the first information during another period subsequent to the second time period when the first device receives the second information during the second time period.

5. The method of claim 1, wherein transmitting the notification when the first device receives the second information during the second time period comprises:
transmitting the notification to at least one of the first device, a device of the user, a device of another user, a device of the first area, a display of the first area, a display proximate to the first area, and a display of a second area different than the first area, the notification being one or more of an audible indication, text, graphical indication, and a text to voice message.

6. The method of claim 1, wherein the first area is one of
a storage unit affixed to or stored in a vehicle including a box affixed to a box truck, a trailer affixed to a platform having one or more sets of wheels and a hitch assembly for towing by the vehicle, and a unit loading device (ULD) stored in an aircraft, and
a storage area integrated in at least a portion of a vehicle including a van and a sports utility vehicle (SUV).

7. The method of claim 1, wherein
the first device is one of a radio frequency identification (RFID) reader or transceiver and a Bluetooth Low Energy (BLE) equipped device, the first device being positioned proximate to or within the first area, and
each of the first element and the second element is one of a radio frequency identification (RFID) tag and a Bluetooth Low Energy (BLE) beacon.

8. A device, comprising:
a memory configured to store computer executable instructions; and
a processor configured to interface with the memory and execute the computer executable instructions to cause the processor to:
receive, during a first period, first information of at least one first element associated with a user within a first area and second information of at least one second element associated with an object positioned within the first area,
determine, based on the second information, whether the object is associated with the first area,
identify the at least one second element as anomalous when the object is not associated with the first area,
determine whether the device receives the first information during a second time period,
determine whether the device receives the second information during the second time period when the device does not receive the first information during the second time period, and
transmit a notification when the device receives the second information during the second time period, the notification being indicative of the object not being associated with the first area and being positioned within the first area.

9. The device of claim 8, wherein the instructions, when executed, further cause the processor to:
remove the identification of the at least one second element as anomalous when the device does not receive the second information during the second time period.

10. The device of claim 8, wherein the instructions, when executed, further cause the processor to:
determine whether an elapsed time period exceeds a threshold when the device receives the first information during the second time period,
determine whether the device receives the second information during the second time period when the elapsed time period exceeds the threshold, and
determine the object is not positioned within the first area and remove the identification of the at least one second element as anomalous when the device does not receive the second information during the second time period.

11. The device of claim 8, wherein the instructions, when executed, further cause the processor to:
determine whether an elapsed time period exceeds a threshold when the device receives the first information during the second time period,
determine whether the device receives the second information during the second time period when the elapsed time period exceeds the threshold, and
determine whether the device receives the first information during another period subsequent to the second time period when the device receives the second information during the second time period.

12. The device of claim 8, wherein transmitting the notification when the device receives the second information during the second time period comprises:
transmitting the notification to at least one of a device of the user, a device of another user, a device of the first area, a display of the first area, a display proximate to the first area, and a display of a second area different than the first area, the notification being one or more of an audible indication, text, graphical indication, and a text to voice message.

13. The device of claim 8, wherein the first area is one of
a storage unit affixed to or stored in a vehicle including a box affixed to a box truck, a trailer affixed to a platform having one or more sets of wheels and a hitch assembly for towing by the vehicle, and a unit loading device (ULD) stored in an aircraft, and
a storage area integrated in at least a portion of a vehicle including a van and a sports utility vehicle (SUV).

14. The device of claim 8, wherein
the device is one of a radio frequency identification (RFID) reader or transceiver and a Bluetooth Low Energy (BLE) equipped device, the device being positioned proximate to or within the first area, and
each of the first element and the second element is one of a radio frequency identification (RFID) tag and a Bluetooth Low Energy (BLE) beacon.

15. A non-transitory computer readable medium having instructions stored thereon which, when executed by a processor, causes the processor to carry out the steps of:
receiving, by a first device and during a first period, first information of at least one first element associated with a user within a first area and second information of at least one second element associated with an object positioned within the first area;
determining, based on the second information, whether the object is associated with the first area;
identifying the at least one second element as anomalous when the object is not associated with the first area;
determining whether the first device receives the first information during a second time period;
determining whether the first device receives the second information during the second time period when the first device does not receive the first information during the second time period; and
transmitting a notification when the first device receives the second information during the second time period, the notification being indicative of the object not being associated with the first area and being positioned within the first area.

16. The non-transitory computer readable medium of claim 15, wherein the instructions, when executed, further cause the processor to carry out the step of:
removing the identification of the at least one second element as anomalous when the first device does not receive the second information during the second time period.

17. The non-transitory computer readable medium of claim 15, wherein the instructions, when executed, further cause the processor to carry out the steps of:
determining whether an elapsed time period exceeds a threshold when the first device receives the first information during the second time period;
determining whether the first device receives the second information during the second time period when the elapsed time period exceeds the threshold; and
determining the object is not positioned within the first area and removing the identification of the at least one second element as anomalous when the first device does not receive the second information during the second time period.

18. The non-transitory computer readable medium of claim 15, wherein the instructions, when executed, further cause the processor to carry out the steps of:
determining whether an elapsed time period exceeds a threshold when the first device receives the first information during the second time period;
determining whether the first device receives the second information during the second time period when the elapsed time period exceeds the threshold; and
determining whether the first device receives the first information during another period subsequent to the second time period when the first device receives the second information during the second time period.

19. The non-transitory computer readable medium of claim 15, wherein transmitting the notification when the first device receives the second information during the second time period comprises:
transmitting the notification to at least one of the first device, a device of the user, a device of another user, a device of the first area, a display of the first area, a display proximate to the first area, and a display of a second area different than the first area, the notification being one or more of an audible indication, text, graphical indication, and a text to voice message.

20. The non-transitory computer readable medium of claim 15, wherein
the first device is one of a radio frequency identification (RFID) reader or transceiver and a Bluetooth Low Energy (BLE) equipped device, the first device being positioned proximate to or within the first area, and
each of the first element and the second element is one of a radio frequency identification (RFID) tag and a Bluetooth Low Energy (BLE) beacon.
